(19) United States
(12) Patent Application Publication
(10) Pub. No.: US 2026/0277393 A1
(43) Pub. Date: Sep. 17, 2026

(54) INFORMATION PROCESSING METHOD, INFORMATION PROCESSING DEVICE, AND NON-TRANSITORY COMPUTER READABLE STORAGE MEDIUM

(71) Applicant: PANASONIC INTELLECTUAL PROPERTY MANAGEMENT CO., LTD., Osaka (JP)

(72) Inventor: Minami NAKA, Osaka (JP)

(73) Assignee: PANASONIC INTELLECTUAL PROPERTY MANAGEMENT CO., LTD., Osaka (JP)

(21) Appl. No.: 19/661,188

(22) Filed: Apr. 28, 2026

Related U.S. Application Data
(63) Continuation of application No. PCT/JP2024/038796, filed on Oct. 31, 2024.
(60) Provisional application No. 63/546,978, filed on Nov. 2, 2023.

(30) Foreign Application Priority Data
Aug. 9, 2024 (JP) 2024-134002

(51) Int. Cl. G06F 3/04817

(52) U.S. Cl. CPC G06F 3/04817

(57) ABSTRACT

An information processing method is an information processing method in a computer and the information processing method includes: displaying a bird's-eye view on a display of a terminal device; displaying, on the bird's-eye view, a plurality of imaging point icons indicating a series of a plurality of imaging points; and upon detection of a selection of one first imaging point icon among the plurality of imaging point icons, displaying a first moving image linked to a first imaging point indicated by the first imaging point icon, in which the first moving image is a moving image between imaging times at each of two second imaging points indicated by two second imaging icons displayed before and after the first imaging point icon.

### FIELD OF INVENTION

The present disclosure relates to a technique of displaying images captured at a plurality of imaging points.

### BACKGROUND ART

Patent Literature 1 discloses a technique of clipping a moving image at a set time before and after a time of passing a utility pole from an image recorded in a drive recorder mounted on a vehicle with reference to the time of passing the utility pole and displaying the clip moving image.

In the technique of Patent Literature 1, in order to clip a moving image from the image recorded on the drive recorder, it is necessary to cause a user to set the time before and after the time of passing a reference point. Therefore, even if the user tries to clip a moving image between predetermined points before and after the reference point, it is difficult to accurately set the moving time from the reference point to each predetermined point, and there is a problem that the moving image cannot be appropriately clipped.

Patent Literature 1: JP 2023-144527 A

### SUMMARY OF THE INVENTION

The present disclosure has been made to solve such a problem, and an object of the present disclosure is to provide a technique of appropriately knowing a status from a selected imaging point to two imaging points before and after the selected imaging point.

An information processing method according to an aspect of the present disclosure is an information processing method in a computer and the information processing method includes: displaying a bird's-eye view on a display of a terminal device; displaying, on the bird's-eye view, a plurality of imaging point icons indicating a series of a plurality of imaging points; and upon detection of a selection of one first imaging point icon among the plurality of imaging point icons, displaying a first moving image linked to a first imaging point indicated by the first imaging point icon, in which the first moving image is a moving image between imaging times at each of two second imaging points indicated by two second imaging icons displayed before and after the first imaging point icon.

### BRIEF DESCRIPTION OF THE DRAWINGS

FIG. 1 is an overall configuration diagram of an information processing system.

FIG. 2 is a diagram showing an example of a design drawing displayed on a display of an information terminal.

FIG. 3 is a diagram showing an example of a screen displayed in a case where a first imaging point icon is selected.

FIG. 4 is a diagram showing a display example of a first moving image.

FIG. 5 is a flowchart showing a first example of processing of the information processing system during an imaging operation.

FIG. 6 is a flowchart showing an example of peripheral moving image display processing.

FIG. 7 is a flowchart showing a second example of the processing of the information processing system during the imaging operation.

FIG. 8 is an explanatory diagram of a modification of a method of creating a partial moving image corresponding to each imaging point.

### DETAILED DESCRIPTION

### Background of Present Disclosure

There has been developed a user interface that displays a plurality of imaging point icons indicating a series of a plurality of imaging points where a building site or the like is actually captured on a two-dimensional design drawing of the building site, and displays an image captured at an imaging point indicated by one imaging point icon when one imaging point icon is selected. As a result, an administrator of the building site can know the status of the building site without visiting the building site.

In such a user interface, a function of displaying not only a captured image of a selected imaging point but also a moving image up to two imaging points before and after the imaging point has been studied. As a result, a supervisor can appropriately know not only the selected imaging point but also a progress status of construction from the imaging point to two imaging points before and after the selected imaging point. In the technique of Patent Literature 1, it is difficult to cause the user to accurately set a moving time from the selected imaging point to two imaging points before and after the selected imaging point, and thus, it is difficult to implement the above function.

Therefore, the present inventors have intensively studied a technique of appropriately knowing a status from a selected imaging point to two imaging points before and after the selected imaging point, and have arrived at the present disclosure described below.
(1) An information processing method according to an aspect of the present disclosure is an information processing method in a computer and the information processing method includes: displaying a bird's-eye view on a display of a terminal device; displaying, on the bird's-eye view, a plurality of imaging point icons indicating a series of a plurality of imaging points; and upon detection of a selection of one first imaging point icon among the plurality of imaging point icons, displaying a first moving image linked to a first imaging point indicated by the first imaging point icon, in which the first moving image is a moving image between imaging times at each of two second imaging points indicated by two second imaging icons displayed before and after the first imaging point icon.

In this configuration, the moving image between the imaging times at each of the two second imaging points before and after the selected first imaging point is displayed. Therefore, it is possible to appropriately know the status from the selected first imaging point to the two second imaging points before and after the selected first imaging point.
(2) The information processing method according to (1) may further include, upon detection of the selection of the first imaging point icon, causing display modes of the two second imaging point icons displayed in the bird's-eye view to be different from a display mode of another imaging point icon.

In this configuration, in a case where the selection of the first imaging point icon is detected, the display modes of the two second imaging point icons displayed in the bird's-eye view are different from the display modes of the other imaging point icons. Therefore, the user can easily know which moving image between the imaging times at each of the two imaging points is displayed by viewing the bird's-eye view.
(3) In the information processing method according to (1) or (2), the displaying of the first moving image may include displaying time information in which the imaging time of an image included in the first moving image and currently displayed, an imaging time at the first imaging point, and the imaging time at each of the two second imaging points are associated with each other.

In this case, since the time information is displayed, the user can know a relative positional relationship between the imaging point of the currently displayed image included in the first moving image and each of the first imaging point and the two second imaging points.
(4) In the information processing method according to (3), the displaying of the time information may include displaying the imaging time at the first imaging point with an icon having a display mode same as a display mode of the first imaging point icon displayed in the bird's-eye view, and displaying the imaging time at each of the two second imaging points with two icons having a display mode same as the display mode of each of the two second imaging point icons displayed in the bird's-eye view.

In this case, the imaging time at the first imaging point included in the time information is displayed as an icon having a display mode same as the first imaging point icon displayed in the bird's-eye view. The imaging time at each of the two second imaging points included in the time information is displayed as two icons having a display mode same as each of the two second imaging point icons displayed in the bird's-eye view. Therefore, the user can intuitively know the relative positional relationship between the imaging point of the currently displayed image included in the first moving image and each of the first imaging point and the two second imaging points.
(5) The information processing method according to any one of (1) to (4) may further include: extracting a first partial moving image that is a moving image between imaging times at each of the imaging points before and after each of the imaging points from an entire moving image that is a moving image between imaging times at each of an imaging start point and an imaging end point of the plurality of imaging points; and storing the first partial moving image in association with each of the imaging points, in which the displaying of the first moving image may include displaying the first partial moving image corresponding to the first imaging point as the first moving image.

In this configuration, upon detection of the selection of the first imaging point icon, the first partial moving image stored in association with the first imaging point is displayed as the first moving image. Therefore, every time the selection of the first imaging point icon is detected, it is possible to display the first image at the time of selecting the first imaging point icon more quickly than in a case where the moving image between the imaging times at each of the two second imaging points indicated by the two second imaging icons displayed before and after the first imaging point icon is extracted from the entire moving image and displayed.
(6) The information processing method according to any one of (1) to (4) may further include extracting a second partial moving image that is a moving image from a first average time that is an average of imaging times at an imaging point before each of the imaging points and at each of the imaging points to a second average time that is an average of imaging times at each of the imaging points and at each of the imaging points after each of the imaging points from an entire moving image that is a moving image between imaging times at each of an imaging start point and an imaging end point of the plurality of imaging points; and storing the second partial moving image in association with each of the imaging points, in which displaying the first moving image may include displaying, as the first moving image, a moving image obtained by combining a moving image at and after an imaging time at a third imaging point in the second partial moving image corresponding to the third imaging point that is a second imaging point before the first imaging point, the second partial moving image corresponding to the first imaging point, and a moving image before an imaging time at a fourth imaging point in the second partial moving image corresponding to a fourth imaging point that is a second imaging point after the first imaging point.

In this case, a second partial moving image that is a moving image from the first average time to the second average time is stored in association with each imaging point. Then, the moving image combined by using the second partial moving image associated with each of the third imaging point, the first imaging point, and the fourth imaging point is displayed as the first moving image. Therefore, it is possible to store the second partial moving image corresponding to each imaging point required for configuring the first moving image without overlapping with the second partial moving image corresponding to another imaging point.
(7) The information processing method according to any one of (1) to (4) may further include extracting a third partial moving image that is a moving image between imaging times at each of the imaging points and each of the imaging points one after each of the imaging points, from an entire moving image that is a moving image between imaging times at each of an imaging start point and an imaging end point of the plurality of imaging points; and upon detection that the captured image of the predetermined object is included in the third partial moving image, extracting, from the entire moving image, an object moving image that is a moving image including only an image including a captured image of a predetermined object and having a period overlapping with the third partial moving image, and storing a fourth partial moving image that is a moving image obtained by combining the third partial moving image and the object moving image so that periods do not overlap in association with each of the imaging points, and upon detection that the captured image of the predetermined object is not included in the third partial moving image, storing the third partial moving image in association with each of the imaging points, in which displaying the first moving image may include displaying, as the first moving image, a moving image obtained by combining the third partial moving image or the fourth partial moving image corresponding to the second imaging point one before the first imaging point and the third partial moving image or the fourth partial moving image corresponding to the first imaging point so that periods do not overlap.

In this configuration, a moving image obtained by combining the third partial moving image or the fourth partial moving image corresponding to the second imaging point one before the first imaging point and the third partial moving image or the fourth partial moving image corresponding to the first imaging point so that the periods do not overlap is displayed as the first moving image. The fourth partial moving image is a moving image obtained by combining the third partial moving image and the object moving image so that the periods do not overlap.

Therefore, the user can view a moving image including a captured image of a predetermined object not only between the imaging times at the two second imaging points one before and one after the first imaging point but also in a period immediately before and/or immediately after the imaging times. As a result, the user can gaze at the predetermined object.

(8) In the information processing method according to (7), detecting whether a captured image of the predetermined object is included may include detecting that a captured image of the predetermined object is included in a third partial moving image when one or more imaging times obtained by inputting the entire moving image to a model obtained by machine learning a relationship between a second moving image that is a moving image captured in a space including the plurality of imaging points and includes one or more captured images of an annotation object existing in the space and an imaging time of each of one or more captured images of the annotation object included in the second moving image is included in a period of the third partial moving image, and the annotation object may be an object designated by a user as a target to be annotated.

In this case, the user can view a moving image including the captured image of the annotation object not only between the imaging times at each of the two second imaging points before and after the first imaging point but also in the period immediately before and/or immediately after the imaging times. As a result, the user can gaze at an object that can be designated as a target to be annotated.
(9) In the information processing method according to any one of (1) to (6), an imaging point before one imaging point among the plurality of imaging points may be n imaging points before the one imaging point, and an imaging point after the one imaging point may be m imaging points after the one imaging point, and the n and the m may be natural numbers that are one or more.

In this case, since the moving image between the imaging times at each of the second imaging points n imaging points before and m imaging points after the selected first imaging point is displayed, it is possible to appropriately know the status from the selected first imaging point to the two second imaging points n imaging points before and m imaging points after the selected first imaging point.

The present disclosure can be implemented not only as the information processing method of executing the characteristic processing as described above, but also as an information processing device or the like having a characteristic configuration corresponding to characteristic processing executed by the information processing method. The present disclosure can also be implemented as a computer program that causes a computer to execute characteristic processing included in such an information processing method. Therefore, an effect similar to the effect in the above information processing method can also be achieved by another aspect described below.
(10) An information processing device according to another aspect of the present disclosure is an information processing device including a processor, the processor executing processing of displaying a bird's-eye view on a display of a terminal device, displaying, on the bird's-eye view, a plurality of imaging point icons indicating a series of a plurality of imaging points, and upon detection of a selection of one first imaging point icon among the plurality of imaging point icons, displaying a first moving image linked to a first imaging point indicated by the first imaging point icon, in which the first moving image is a moving image between imaging times at each of two second imaging points indicated by two second imaging icons displayed before and after the first imaging point icon.
(11) A non-transitory computer readable storage medium according to still another aspect of the present disclosure is a non-transitory computer readable storage medium storing an information processing program that causes a computer to display a bird's-eye view on a display of a terminal device, display, on the bird's-eye view, a plurality of imaging point icons indicating a series of a plurality of imaging points, and upon detection of a selection of one first imaging point icon among the plurality of imaging point icons, display a first moving image linked to a first imaging point indicated by the first imaging point icon, in which the first moving image is a moving image between imaging times at each of two second imaging points indicated by two second imaging icons displayed before and after the first imaging point icon.

The present disclosure can be also implemented as an information processing system that is operated by such an information processing program. It is needless to say that such a computer program can be distributed via a computer-readable non-transitory recording medium such as a CD-ROM or via a communication network such as the Internet.

Hereinafter, embodiments of the present disclosure will be described with reference to the accompanying drawings. Note that all embodiments described below show specific examples of the present disclosure. Numerical values, shapes, constituent elements, steps, order of the steps, and the like of the following embodiments are merely examples, and do not intend to limit the present disclosure. A constituent element not described in an independent claim representing a highest concept among constituent elements in the embodiments below is described as an optional constituent element. In all the embodiments, respective contents can be combined.

### Embodiments

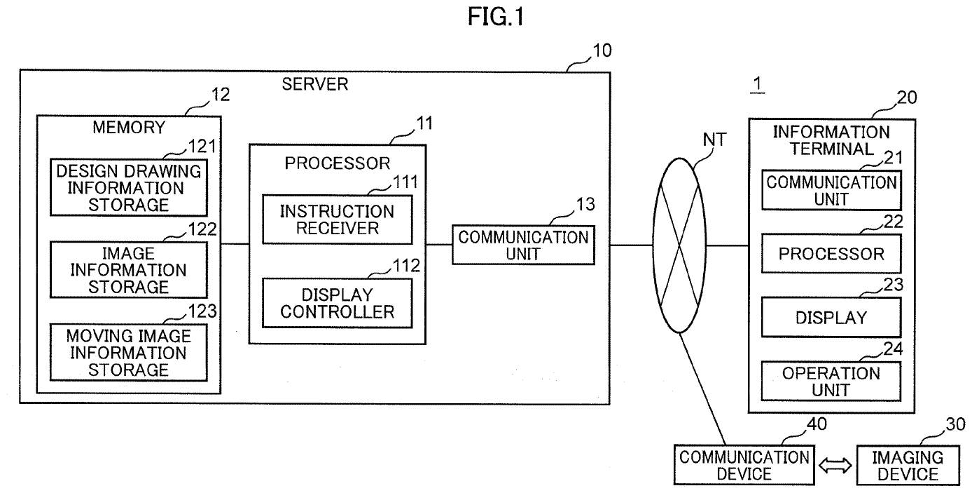

FIG. 1 is an overall configuration diagram of an information processing system 1. The information processing system 1 is a system that extracts and displays a moving image between imaging times at each of two imaging points before and after a selected imaging point from a moving image between imaging times at each of top and last imaging points among a series of a plurality of imaging points.

As shown in FIG. 1, the information processing system 1 includes a server 10, an information terminal 20 (terminal device), an imaging device 30, and a communication device 40. The server 10 (an information processing device and a computer), the information terminal 20, and the communication device 40 are communicably connected to each other via a network NT. An example of the network NT is the Internet.

The server 10 is, for example, a cloud server configured by one or a plurality of computers. However, this is an example, and the server 10 may be configured by an edge server or may be implemented in the information terminal 20. An aspect in which the server 10 is implemented in the information terminal 20 is an example of an aspect in which the information terminal 20 is configured by the information processing device.

The information terminal 20 is carried by a user. The user is, for example, an administrator of a predetermined space imaged by the imaging device 30. The predetermined space is, for example, a construction site. However, this is an example, and the predetermined space may be a building site, a factory, a store, an office, or the like. The information terminal 20 may be configured by, for example, a portable computer such as a smartphone or a tablet computer, or may be configured by a stationary computer. The information terminal 20 displays various images and screens on the display in accordance with a display instruction from the server 10. Although one information terminal 20 is shown in the example of FIG. 1, a plurality of information terminals may be connected to the server 10 via the network NT. The information terminal 20 includes a communication unit 21, a processor 22, a display 23, and an operation unit 24.

The communication unit 21 is a communication interface that connects the information terminal 20 to the network NT. The communication unit 21 transmits various instructions received from the user by the operation unit 24 to the server 10. The communication unit 21 receives a display instruction of various images and screens from the server 10.

The processor 22 includes, for example, a central processing unit, and displays various images and screens on the display 23 in accordance with display instructions of various images and screens received by the communication unit 21.

The display 23 is configured by various display devices such as a liquid crystal display and an organic electro-luminescence (EL) display, and displays various images and screens under the control of the processor 22.

The operation unit 24 is configured by a keyboard, a touch panel, a mouse, and the like, and receives various instructions input by the user.

The communication device 40 is configured by, for example, a portable information terminal such as a smartphone or a tablet computer, and connects the imaging device 30 to the network NT. The communication device 40 and the imaging device 30 are connected via a proximity wireless communication path such as Bluetooth (registered trademark).

The imaging device 30 is configured by, for example, an omnidirectional camera, and captures a moving image at a predetermined frame rate. The omnidirectional camera is also referred to as a 360 degree camera, and is a camera capable of acquiring an omnidirectional image of 360 degrees. The imaging device 30 is, for example, a portable imaging device carried by a photographer. The photographer is, for example, a worker or a site supervisor at a construction site. Note that the imaging device 30 may be configured by a normal camera.

The photographer moves in the construction site while imaging the construction site with the imaging device 30. At an imaging start point, the photographer presses an imaging button of the imaging device 30 in a direction (thereafter, reference direction) based on an imaging direction of the imaging device 30. In the following description, the reference direction is the north direction. However, the reference direction is not limited to the north direction, and may be another direction. When reaching an imaging end point, the photographer presses the imaging button again. Accordingly, the imaging device 30 ends imaging. When imaging is completed, the imaging device 30 transmits the captured moving image to the communication device 40.

The communication device 40 receives the moving image transmitted by the imaging device 30. In this case, the communication device 40 displays a design drawing of the construction site, and receives designation by the photographer of the position of the imaging start point and the position of the imaging end point on the design drawing. The imaging start point and the imaging end point are specified by the photographer inputting an instruction to designate the position on a design drawing screen of the site displayed on the display of the communication device 40.

Two-dimensional coordinate axes are defined on the design drawing screen. In the two-dimensional coordinate axes, for example, the east-west direction in the design drawing is defined as a horizontal axis or an X axis, and the north-south direction is defined as a vertical axis or a Y axis. Therefore, the imaging start point and the imaging end point are defined by two-dimensional coordinate values. The communication device 40 transmits imaging information including a captured moving image to the server 10 via the network NT.

The imaging information is generated every time one imaging operation is performed. One imaging operation refers to a series of operations from the start of imaging to the end of imaging at a construction site by a worker with the imaging device 30. The imaging information includes a moving image between imaging times at each of the imaging start point and the imaging end point, the moving image being captured in one imaging operation, and meta information of the moving image. The meta information includes an imaging ID, an imaging start time, an imaging end time, a design drawing ID, an imaging start point, and an imaging end point.

The imaging ID is an identifier for identifying imaging operations. The imaging start time is an imaging time at the imaging start point. The imaging end time is an imaging time at the imaging end point. The imaging time is acquired by, for example, a clock included in the imaging device 30. Note that the imaging time may include the year, month, and day when imaging is performed. Similarly, various times in the following description may include year, month, and day. The design drawing ID is an identifier for identifying the design drawing of the predetermined space in which the moving image is captured. The imaging start point and the imaging end point are used to specify the imaging point and the imaging direction of each image constituting the moving image.

The server 10 includes a processor 11, a memory 12, and a communication unit 13 The processor 11 is configured by, for example, a central processing unit (CPU). The processor 11 includes an instruction receiver 111 and a display controller 112. The instruction receiver 111 and the display controller 112 may be implemented by the processor 11 executing the information processing program, or may be configured by a dedicated hardware circuit such as an ASIC. The information processing program may be recorded on a non-transitory computer-readable recording medium.

The communication unit 13 is a communication interface that connects the server 10 to the network NT. The communication unit 13 receives the imaging information transmitted by the communication device 40. The communication unit 13 receives various instructions from the user from the information terminal 20. The communication unit 13 transmits a display instruction of various images and screens to the information terminal 20.

The memory 12 is configured by a nonvolatile rewritable storage device such as a hard disk drive or a solid state drive. The memory 12 includes a design drawing information storage 121, an image information storage 122, and a moving image information storage 123.

The design drawing information storage 121 stores design drawing information. The design drawing information is information in which a design drawing ID and a design drawing of the predetermined space identified by the design drawing ID are associated with each other. The design drawing is a diagram showing a design of a building site, and may be a plan view, a blueprint, a map, a perspective view, or the like of the building site. The design drawing is one example of a bird's-eye view. The bird's-eye view can also be referred to as an overhead view, and may be a diagram viewed from above or a diagram viewed from high above.

The image information storage 122 stores image information. The image information is information in which a plurality of images included in a moving image captured by the imaging device 30 is associated with the meta information of each image. The meta information includes the imaging ID, the imaging time, the design drawing ID, the imaging point, and the imaging direction. Specifically, the processor 11 creates the image information on the basis of the imaging information received by the communication unit 13, and stores the created image information in the image information storage 122.

More specifically, the processor 11 acquires the imaging start point and the imaging end point from the meta information included in the imaging information received by the communication unit 13. By using a visual simultaneous localization and mapping (SLAM) technology, the processor 11 specifies an imaging point of each image from the imaging start point, the imaging end point, and a plurality of images (frames) constituting a moving image included in the imaging information. The imaging point of each image is represented by two-dimensional coordinate values on the design drawing. The processor 11 also specifies the imaging direction of each image by using the visual SLAM technology. The imaging direction of each image is represented by, for example, a three-dimensional polar coordinate vector with the north direction as the reference direction.

Since the imaging device 30 captures a moving image at a predetermined frame rate, the number of images constituting the moving image is defined in units of frame cycles. In order to store the image information including all the images constituting the captured moving image and the meta information of each image, a huge storage capacity is required in the memory 12. Therefore, the processor 11 determines a plurality of imaging points as targets to be displayed on the design drawing by a predetermined method.

For example, the processor 11 extracts an image of a preset key frame from a plurality of images constituting a moving image by using the visual SLAM technology, and determines an imaging point corresponding to the image. However, the method of determining the imaging point is not limited to this method. For example, the processor 11 may partition a design drawing of the predetermined space in which the moving image is captured into a plurality of regions, and determine the plurality of imaging points so that one imaging point is included for each predetermined number of areas. Alternatively, the processor 11 may extract images at time intervals (for example, one second, five seconds, ten seconds, one minute, or the like) sufficiently longer than the frame rate from the plurality of images constituting the moving image, and determine the imaging point corresponding to the image.

The processor 11 extracts an image (subsequently, captured image) captured at each determined imaging point from the moving image included in the imaging information. The processor 11 acquires the meta information from the imaging information, and adds the imaging point and the imaging direction of the captured image at the imaging point to the meta information. The processor 11 creates image information associated with the meta information and the captured image at each imaging point, and stores the created image information in the image information storage 122.

The moving image information storage 123 stores a moving image (hereinafter, the entire moving image) between imaging times at each of the imaging start point and the imaging end point included in the imaging information received by the communication unit 13. Specifically, the processor 11 stores the entire moving image included in the imaging information received by the communication unit 13 in the moving image information storage 123.

The moving image information storage 123 stores a partial moving image in association with each imaging point to be displayed on the design drawing. The partial moving image is a moving image including a plurality of captured images at and around each imaging point. Specifically, the processor 11 extracts, from the entire moving image, a moving image (first partial moving image) between imaging times at each of two imaging points one before and one after each imaging point as a partial moving image, and stores the partial moving image in the moving image information storage 123 in association with each imaging point.

The instruction receiver 111 acquires an instruction by the user input by the information terminal 20. Specifically, in a case where the communication unit 13 receives an instruction from the user from the information terminal 20, the instruction receiver 111 detects the input of the instruction. The instruction includes, for example, a selection instruction of a design drawing, a designation instruction of an imaging time, a selection instruction of an imaging point icon, a display instruction of a selected image, a display instruction of a peripheral moving image, and an annotation instruction of an object.

The selection instruction of a design drawing is an instruction to select a design drawing corresponding to a design ID input by the user as a design drawing of a processing target. The instruction to designate the imaging time is an instruction to designate the imaging time input by the user as the imaging time of the processing target. The imaging point icon is an icon displayed in a superimposed manner at the position of the imaging point included in the design drawing. The selection instruction of the imaging point icon is an instruction to select, by the user, the imaging point icon selected from among the plurality of imaging point icons displayed in a superimposed manner on the design drawing as the imaging point icon of the processing target.

The display instruction of the selected image is an instruction to display the captured image at the imaging point indicated by the imaging point icon selected as the processing target. The display instruction of the peripheral moving image is an instruction to display a moving image between imaging times at each of two imaging points before and after the imaging point indicated by the imaging point icon selected as the processing target. The annotation instruction of the object is an instruction to annotate the object included in the captured image designated by the user.

In a case where the instruction receiver 111 detects the input of a selection instruction of the design drawing, the display controller 112 reads the design drawing selected by the selection instruction from the design drawing information storage 121. The display controller 112 displays the read design drawing on the display 23 of the information terminal 20.

In a case where the instruction receiver 111 detects the input of the instruction to designate the imaging time, the display controller 112 displays, in a superimposed manner, a plurality of imaging point icons indicating a series of a plurality of imaging points including the imaging point where the imaging is performed at the imaging time designated by the instruction on the design drawing.

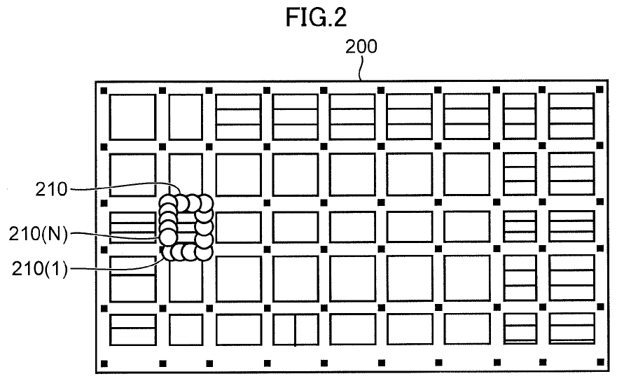

FIG. 2 is a diagram showing an example of a design drawing 200 displayed on the display 23 of the information terminal 20. FIG. 2 shows an example in which a series of N imaging point icons 210 are displayed in a superimposed manner on the design drawing 200. In this example, the imaging point icon 210 is configured by a white circular image. The imaging point icon 210(1) indicates a top (first) imaging point of the series of N imaging points. The imaging point icon 210(N) indicates a last (Nth) imaging point of the series of N imaging points.

Here, it is assumed that when the user selects the imaging point icon 210 indicating one imaging point from among the plurality of imaging point icons 210 displayed in a superimposed manner on the design drawing 200, the instruction receiver 111 detects the input of the selection instruction of the imaging point icon 210. Hereinafter, the imaging point icon 210 selected by the user is referred to as a first imaging point icon 210(x). An imaging point indicated by the first imaging point icon 210(x) is described as a first imaging point x.

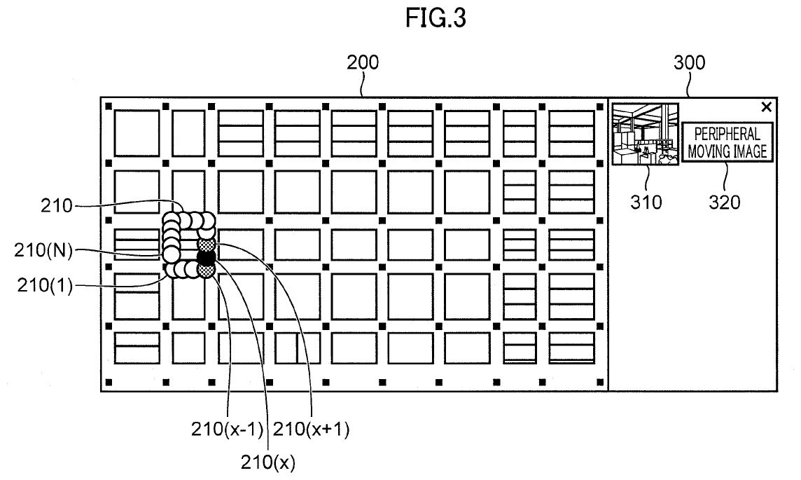

FIG. 3 is a diagram showing an example of the screen displayed in a case where the first imaging point icon 210(x) is selected. In this case, the display controller 112 changes a display mode of the first imaging point icon 210(x). FIG. 3 shows an example in which the color of the first imaging point icon 210(x) is changed from white to black. The method of changing the display mode of the first imaging point icon 210(x) is not limited to this example. For example, the shape of the first imaging point icon 210(x) may be changed, or the filling pattern may be changed to shading, dots, or the like.

Similarly, the display controller 112 makes the display mode of an imaging point icon 210(x−1) indicating an imaging point x−1 one before the first imaging point x indicated by the first imaging point icon 210(x) different from the display modes of the other imaging point icons 210. The display controller 112 makes the display mode of an imaging point icon 210(x+1) indicating an imaging point x+1 one after the first imaging point x different from the display mode of the other imaging point icons 210.

Hereinafter, the imaging point icon 210(x−1) indicating the imaging point x−1 one before the first imaging point x is described as a second imaging point icon 210(x−1), and the imaging point icon 210(x+1) indicating the imaging point x+1 one after the first imaging point x is described as a second imaging point icon 210(x+1). The imaging point x−1 indicated by the second imaging point icon 210(x−1) is described as a second imaging point x−1, and the imaging point x+1 indicated by the second imaging point icon 210(x+1) is described as a second imaging point x+1.

FIG. 3 shows an example in which the filling pattern of the second imaging point icon 210(x−1) and the second imaging point icon 210 (x+1) is changed to dots. The method of changing the display modes of the second imaging point icon 210(x−1) and the second imaging point icon 210(x+1) is not limited to these examples. For example, the shapes of the second imaging point icon 210(x−1) and the second imaging point icon 210(x+1) may be changed, or the color of filling may be changed.

Then, the display controller 112 displays the image display screen 300 so as to be adjacent to the design drawing 200. Note that the present disclosure is not limited thereto, and the display controller 112 may display the image display screen 300 at a position separated from the design drawing 200 on the display 23 of the information terminal 20. Alternatively, the display controller 112 may display the image display screen 300 so as to be superimposed on a part of the design drawing 200.

The display controller 112 acquires the image captured at the first imaging point x from the image information storage 122, and displays a thumbnail image 310 obtained by reducing the image and a moving image display button 320 on the image display screen 300.

Here, when the user clicks the thumbnail image 310, the instruction receiver 111 detects the input of the display instruction of the selected image. In this case, the display controller 112 acquires an image captured at the first imaging point x from the image information storage 122, and displays the image on the display 23 of the information terminal 20.

When the user clicks the moving image display button 320, the instruction receiver 111 detects input of a display instruction of the peripheral moving image. In this case, the display controller 112 generates a first moving image linked to the first imaging point x, and displays the first moving image on the display 23 of the information terminal 20. The first moving image linked to the first imaging point x indicates a moving image included in the entire moving image as a moving image indicating a status around the first imaging point x.

Specifically, when the input of the display instruction of the peripheral moving image is detected, the display controller 112 acquires the partial moving image associated with the first imaging point x from the moving image information storage 123. The partial moving image is a moving image between imaging times at each of two second imaging points x−1 and x+1 one before and one after the first imaging point x. As a result, the display controller 112 generates the acquired partial moving image as the first moving image linked to the first imaging point x. The display controller 112 displays the first moving image on the display 23 of the information terminal 20.

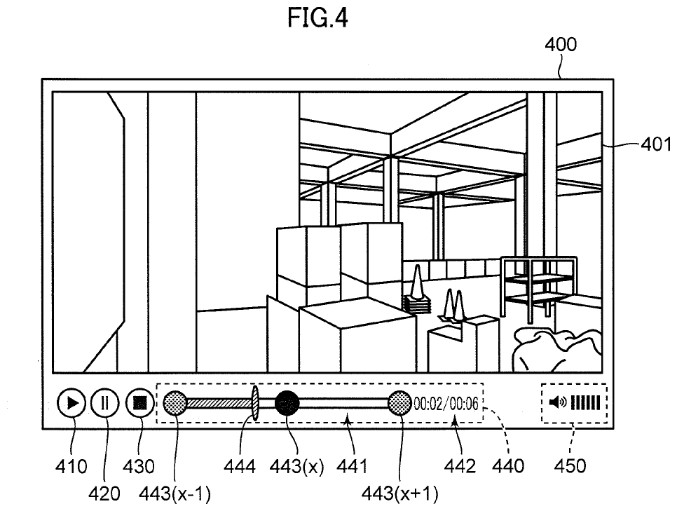

FIG. 4 is a diagram showing a display example of the first moving image. Specifically, the display controller 112 displays a display screen 400 on the display 23 of the information terminal 20. The display screen 400 includes a display field 401, a play button 410, a pause button 420, a stop button 430, a play time adjuster 440, and a volume adjuster 450.

The display controller 112 displays the first moving image in the display field 401. The play button 410, the pause button 420, the stop button 430, and the volume adjuster 450 have similar configurations to configurations of a play button, a pause button, a stop button, and a volume adjuster included in a general moving image player, and thus detailed description thereof will be omitted.

The play time adjuster 440 includes a progress bar 441 for displaying and changing a playback position of the first moving image and a display field 442. The progress bar 441 has a configuration similar to a configuration of a progress bar (seek bar) included in a general moving image player, and thus, a detailed description thereof is omitted. The display controller 112 displays, in a superimposed manner on the progress bar 441, time information in which the imaging time of the currently displayed image included in the first moving image, the imaging time at the first imaging point x, and the imaging time at each of the two second imaging points x−1 and x+1 are associated with each other.

Specifically, the display controller 112 displays, in a superimposed manner as the imaging time at the second imaging point x−1, an icon 443(x−1) having the same display mode as the second imaging point icon 210(x−1) displayed in the design drawing 200 on a left end of the progress bar 441 indicating a start position of reproduction of the first moving image.

The display controller 112 displays, in a superimposed manner as the imaging time at the second imaging point x+1, an icon 443(x+1) having the same display mode as the second imaging point icon 210(x+1) displayed in the design drawing 200 on a right end of the progress bar 441 indicating an end position of reproduction of the first moving image.

The display controller 112 displays, in a superimposed manner, an icon 443(x) having the same display mode as the first imaging point icon 210(x) displayed in the design drawing 200 and indicating the imaging time at the first imaging point x, on a playback position of the image captured at the first imaging point x in the progress bar 441. The playback position of the image captured at the first imaging point x in the progress bar 441 is a position separated rightward from the left end of the progress bar 441 by a product of the ratio of an elapsed time from the imaging time at the second imaging point x−1 to the imaging time at the first imaging point x to a total playback time of the first moving image and a length in a longitudinal direction of the progress bar 441. The total playback time of the first moving image is an elapsed time from the imaging time at the second imaging point x−1 to the imaging time at the second imaging point x+1.

The display controller 112 displays an icon 444 indicating the imaging time of the currently displayed image included in the first moving image at the current playback position of the first moving image in the progress bar 441.

The display controller 112 displays the current playback time (in the example of FIG. 4, “00:02”) of the first moving image and the total playback time (in the example of FIG. 4, “00:06”) of the first moving image in the display field 442.

Therefore, the user can intuitively know a relative positional relationship between the imaging point of the currently displayed image included in the first moving image and each of the first imaging point x and the two second imaging points x−1 and x+1 by viewing the play time adjuster 440.

Note that instead of displaying the icon 443(x−1), the icon 443(x), and the icon 443(x+1) on the progress bar 441 in a superimposed manner, the display controller 112 may display the imaging time at the second imaging point x−1, the imaging time at the first imaging point x, and the imaging time at the second imaging point x+1 on a lower part, an upper part, or the like of the progress bar 441.

(Processing Performed during Imaging Operation)

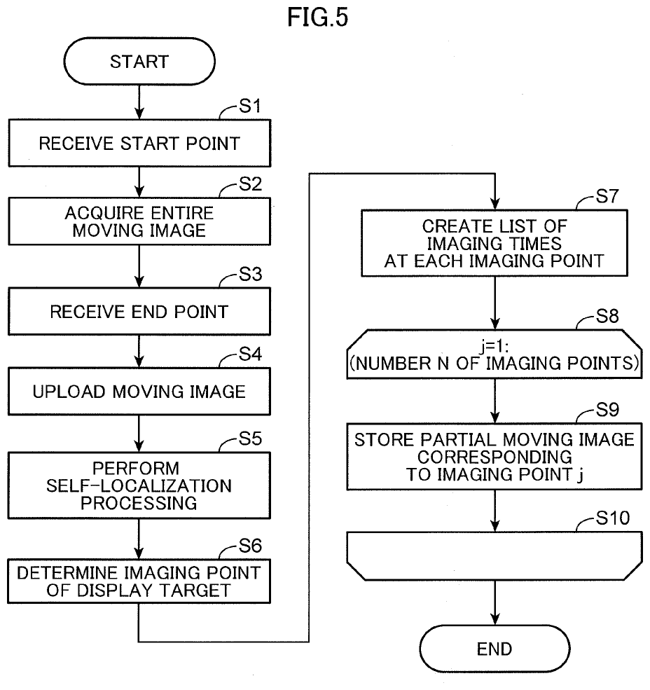

Next, processing of the information processing system 1 performed during one imaging operation by the photographer will be described. FIG. 5 is a flowchart showing a first example of the processing of the information processing system 1 during the imaging operation.

In step S1, the operation unit of the communication device 40 receives an operation of inputting an imaging start point (hereinafter, start point). For example, the photographer inputs an operation of designating a start point for the design drawing screen displayed on the display of the communication device 40. The photographer may designate the start point by tapping on the design drawing screen or may designate the coordinate value of the start point.

Next, at the site, the photographer inputs an imaging start instruction to the imaging device 30 with the imaging direction of the imaging device 30 being the north direction, and performs an imaging operation in the predetermined space. As a result, in step S2, the imaging device 30 acquires the entire moving image that is the moving image between the imaging times at each of the start point and the end point of imaging in the imaging operation.

Next, in step S3, the operation unit of the communication device 40 receives an operation of inputting an imaging end point (hereinafter, end point). For example, the photographer inputs an operation of designating an end point for the design drawing screen displayed on the display of the communication device 40. The photographer may designate the end point by tapping on the design drawing screen or may designate the imaging end point by inputting the coordinate value of the end point.

Next, in step S4, the communication device 40 acquires imaging information including the entire moving image captured by the imaging device 30 from the imaging device 30, and uploads (transmits) the acquired imaging information to the server 10.

Next, in step S5, the display controller 112 calculates, by using self-localization processing, an imaging point of each of the plurality of images constituting the entire moving image included in the imaging information acquired in step S4. Visual simultaneous localization and mapping (VSLAM) can be adopted as the self-localization processing.

Next, in step S6, the display controller 112 determines a plurality of imaging points as targets to be displayed on the design drawing by a predetermined method. For example, the display controller 112 extracts an image of a preset key frame from a plurality of images constituting the entire moving image by using the visual SLAM technology, and determines an imaging point corresponding to the image.

Next, in step S7, the display controller 112 creates a list of imaging times at each imaging point determined in step S6.

Next, in step S8, the display controller 112 starts processing for each of the plurality of imaging points determined in step S6, with each imaging point set as a processing target. Here, a description will be given assuming that there are N (N is an integer of two or more) imaging points. The display controller 112 sets the imaging points of the processing target in the order of imaging time. j is an index that designates an imaging point of the processing target, and takes a value of j=1 to N.

Next, in step S9, the display controller 112 generates a partial moving image corresponding to the imaging point j, and stores the partial moving image in the moving image information storage 123 in association with the imaging point j. Specifically, the display controller 112 performs the following processing with reference to the list of imaging times created in step S7.

The display controller 112 extracts, as the partial moving image corresponding to the imaging point j, a moving image between imaging times at each of an imaging point j−1 one before the imaging point j and an imaging point j+1 one after the imaging point j from the entire moving image included in the imaging information acquired in step S4. The display controller 112 stores the extracted partial moving image in the moving image information storage 123 in association with the imaging point j.

Next, in step S10, the display controller 112 determines whether the processing for all the imaging points j determined in step S6 has been completed. In a case where the processing for all the imaging points j has not been completed, the processing returns to step S8, and the next imaging point is set as the imaging point j of the processing target. On the other hand, in a case where the processing for all the imaging points j has been completed, that is, in a case where the processing for the imaging points j(=N) has been completed, the processing ends.

### (Peripheral Moving Image Display Processing)

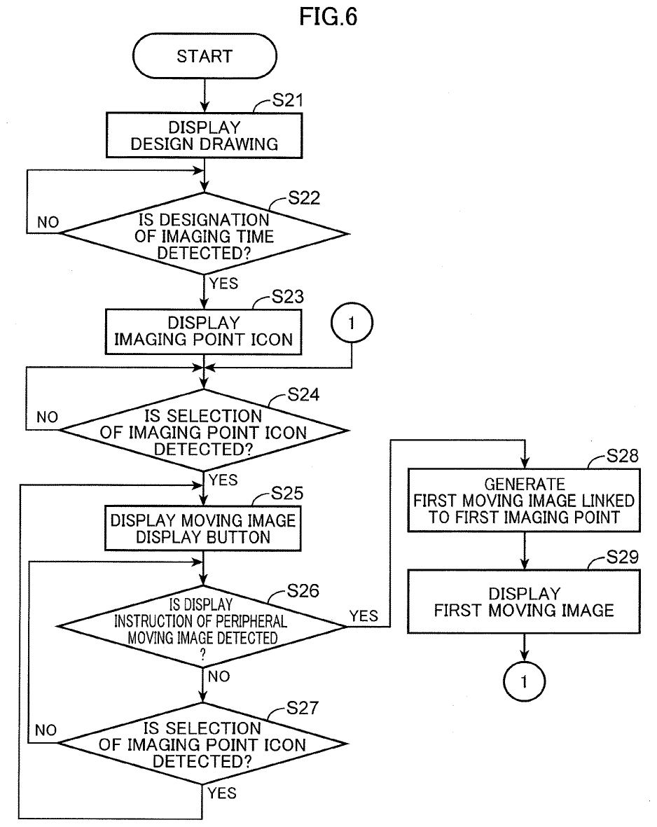

Next, processing of displaying a peripheral moving image of the imaging point indicated by the imaging point icon selected by the user (hereinafter, peripheral moving image display processing) will be described. FIG. 6 is a flowchart showing an example of the peripheral moving image display processing. This processing is started when the instruction receiver 111 detects the input of the selection instruction of the design drawing as a trigger.

In step S21, the display controller 112 displays the design drawing 200 selected by the selection instruction received by the instruction receiver 111 on the display 23 of the information terminal 20.

Next, in step S22, the instruction receiver 111 detects whether an instruction to designate the imaging time has been input. While the instruction receiver 111 does not detect the input of the instruction to designate the imaging time (NO in step S22), the processing in step S22 is repeated. In a case where the instruction receiver 111 detects the input of the instruction to designate the imaging time (YES in step S22), the processing proceeds to step S23.

In step S23, the display controller 112 displays, in a superimposed manner on the design drawing 200 displayed in step S21, the plurality of imaging point icons 210 indicating a series of a plurality of imaging points including the imaging point where the imaging has been performed at the imaging time designated by the designation instruction detected by the instruction receiver 111.

Next, in step S24, the instruction receiver 111 detects whether the selection instruction of the imaging point icon 210 has been input. While the instruction receiver 111 does not detect the input of the selection instruction of the imaging point icon 210 (NO in step S24), the processing in step S24 is repeated. In a case where the instruction receiver 111 detects the input of the selection instruction of the imaging point icon 210 (YES in step S24), the processing proceeds to step S25.

Next, in step S25, the display controller 112 displays the image display screen 300 including the thumbnail image 310 and the moving image display button 320 on the display 23 of the information terminal 20.

At this time, the display controller 112 further changes the display modes of the first imaging point icon 210(x), the second imaging point icon 210(x−1) indicating the second imaging point x−1 one before the first imaging point x indicated by the first imaging point icon 210(x), and the second imaging point icon 210(x+1) indicating the second imaging point x+1 one after the first imaging point x, to display modes different from the display modes of the other imaging point icons 210.

Next, in step S26, the instruction receiver 111 detects whether the display instruction of the peripheral moving image has been input. In a case where the instruction receiver 111 does not detect the input of the display instruction of the peripheral moving image (NO in step S26), the processing proceeds to step S27. In a case where the instruction receiver 111 detects the input of the display instruction of the peripheral moving image (YES in step S26), the processing proceeds to step S28.

Note that, in step S25, the processing of changing the display modes of the first imaging point icon 210(x) and the two second imaging point icons 210(x−1) and 210(x+1) may be performed when the instruction receiver 111 detects the input of the display instruction of the peripheral moving image (YES in step S26).

In step S27, the instruction receiver 111 detects whether a selection instruction of the imaging point icon 210 has been input. In a case where the instruction receiver 111 does not detect the input of the selection instruction of the imaging point icon 210 (NO in step S27), the processing returns to step S26. In a case where the instruction receiver 111 detects the input of the selection instruction of the imaging point icon 210 (YES in step S27), the processing returns to step S25.

In step S28, the display controller 112 generates the first moving image linked to the first imaging point x indicated by the first imaging point icon 210(x) indicated by the selection instruction detected in step S24 or step S27.

Next, in step S29, the display controller 112 displays the display screen 400 on the display 23 of the information terminal 20, and displays the first moving image generated in step S28 in the display field 401 of the display screen 400. The processing returns to step S24 after step S29.

As described above, in the above embodiment, the first moving image that is the moving image between the imaging times at each of the two second imaging points x−1 and x+1 one before and one after the first imaging point x selected by the user is displayed on the display 23 of the information terminal 20. Therefore, the user can appropriately know the status from the selected first imaging point to the two second imaging points before and after the selected first imaging point.

In a case where the selection of the first imaging point icon 210(x) is detected, the display modes of the two second imaging point icons 210(x−1) and 210(x+1) displayed in the bird's-eye view are different from the display modes of the other imaging point icons. Therefore, the user can easily know which moving image between the imaging times at each of the two imaging points is displayed on the display screen 400 by viewing the design drawing 200.

Modifications described below can be adopted for the present disclosure.
(1) In the above embodiment, an example has been described in which the display controller 112 extracts a moving image between imaging times at each of the imaging point j−1 one before the imaging point j and the imaging point j+1 one after the imaging point j from the entire moving image and stores the extracted moving image in the moving image information storage 123 as the partial moving image corresponding to the imaging point j in step S9 (FIG. 5).

Alternatively, however, the display controller 112 may extract, from the entire moving image as a partial moving image, a moving image (second partial moving image) from a first average time that is an average of imaging times at each of the imaging points j−1 one before each of the imaging points j and each of the imaging points j to a second average time that is an average of imaging times at each of the imaging points j and each of the imaging points j+1 one after each of the imaging points j. Then, the display controller 112 may store the partial moving image in the moving image information storage 123 in association with each imaging point j.

Accordingly, in step S28 (FIG. 6), the display controller 112 may acquire, from the moving image information storage 123, not only the partial moving image corresponding to the first imaging point x but also the partial moving images corresponding to the two second imaging points x−1 and x+1 one before and one after the first imaging point x. Then, the display controller 112 may generate the first moving image linked to the first imaging point x by using the acquired three partial moving images.

Specifically, from the partial moving image corresponding to the second imaging point x−1 (third imaging point) one before the first imaging point x, the display controller 112 extracts a moving image at and after the imaging time at the second imaging point x−1 as a first divided moving image. From the partial moving image corresponding to the second imaging point x+1(fourth imaging point) one after the first imaging point x, the display controller 112 extracts a moving image at and before the imaging time at the second imaging point x+1 as a second divided moving image. Then, the display controller 112 generates, as the first moving image, a moving image obtained by combining the first divided moving image, the partial moving image corresponding to the first imaging point x, and the second divided moving image.

In this case, the moving image from the first average time to the second average time is stored in the moving image information storage 123 as a partial moving image corresponding to each imaging point j necessary for constituting the first moving image. Therefore, it is possible to prevent a part or a whole of the partial moving image corresponding to each imaging point j from overlapping with a partial moving image corresponding to another imaging point. As a result, it is possible to prevent a storage capacity of the memory 12 from becoming enormous. (2) Unlike the above embodiment and the above modification (1), the display controller 112 may extract a partial moving image corresponding to each imaging point from the entire moving image, and detect whether a captured image of a predetermined object is included in the partial moving image, as described below. Then, upon detection that the partial moving image includes the captured image of the predetermined object, the display controller 112 may extend the partial moving image corresponding to each imaging point extracted from the entire moving image so that the captured image of the predetermined object is displayed without interruption. This configuration can be achieved as described below, for example.

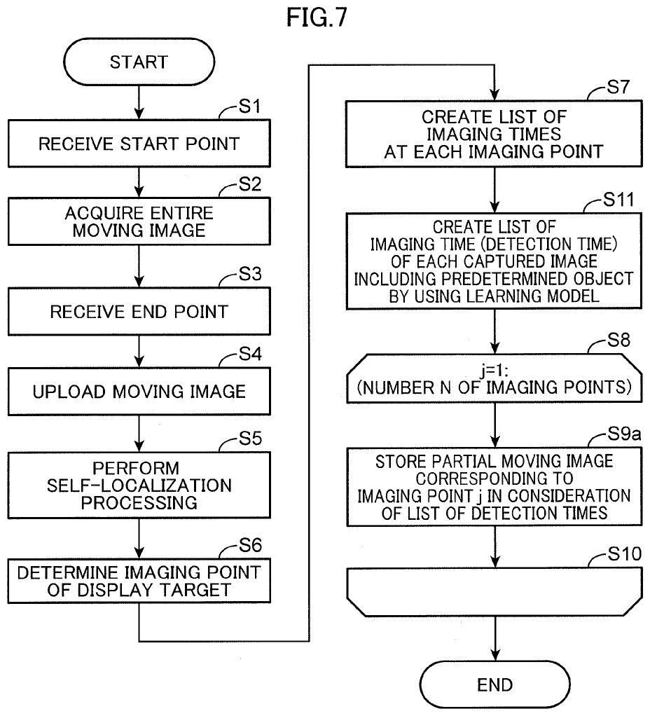

FIG. 7 is a flowchart showing a second example of the processing of the information processing system 1 during the imaging operation. Specifically, the processing shown in FIG. 5 is modified as shown in FIG. 7. More specifically, after step S7, the processing proceeds to step S11. In step S11, the display controller 112 detects the imaging time (hereinafter, detection time) of each of the one or more captured images including the captured image of an annotation object included in the entire moving image by using a learned model constructed by machine learning, and creates a list of the detected one or more detection times.

Specifically, the memory 12 stores in advance a model obtained by machine learning a relationship between a second moving image that is a moving image captured in a space including a series of a plurality of imaging points and is a moving image including one or more captured images of the annotation object existing in the space, and the imaging time of each of the one or more captured images of the annotation object included in the second moving image. The annotation object is an object included in the captured image stored in the image information storage 122, the object being designated by the user as a target to be annotated, the object being indicated by the annotation instruction of the object acquired by the instruction receiver 111.

The display controller 112 acquires (detects) one or more imaging times obtained by inputting the entire moving image included in the imaging information acquired in step S4 to the model stored in the memory 12 as the detection time of each of the one or more captured images including the captured image of the annotation object. The display controller 112 creates a list of detection times of the one or more captured images.

Thereafter, in step S9a obtained by modifying step S9, the display controller 112 generates a partial moving image corresponding to each imaging point j in consideration of the list of detection times created in step S11, and stores the partial moving image in the moving image information storage 123 in association with each imaging point j. Specifically, similarly to step S9, the display controller 112 performs the following processing with reference to the list of imaging times (hereinafter, a first list) created in step S7, and further with reference to the list of detection times (hereinafter, a second list) created in step S11.

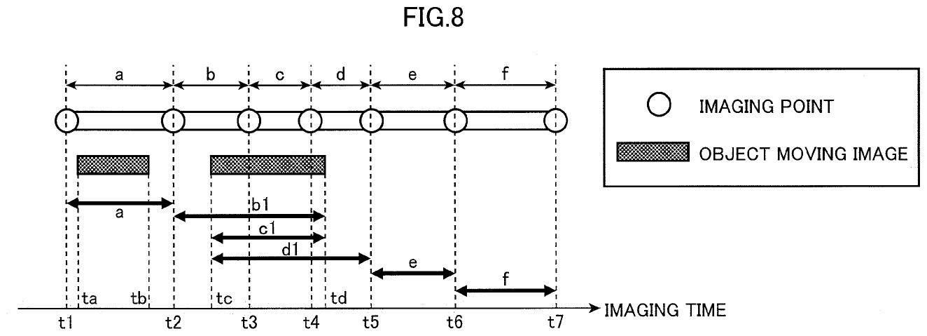

FIG. 8 is an explanatory diagram of a modification of a method of creating the partial moving image corresponding to each imaging point. FIG. 8 shows an example in which, in a case where the first list includes imaging times t1 to t7 at each of the seven imaging points, the display controller 112 creates a partial moving image corresponding to each of the first to sixth imaging points in consideration of a plurality of detection times consecutive in a predetermined frame cycle from time ta to time tb and a plurality of detection times consecutive in a predetermined frame cycle from time tc to time td, which are included in the second list.

In step S9a, the display controller 112 extracts a moving image (third partial moving image) between imaging times at each imaging point j and each imaging point j+1 one after each imaging point j from the entire moving image as a moving image (hereinafter, a partial candidate moving image) that is a candidate for the partial moving image corresponding to each imaging point j.

In the example of FIG. 8, the display controller 112 extracts a moving image in a period a from imaging time t1 at the first imaging point to imaging time t2 at the second imaging point from the entire moving image as a partial candidate moving image corresponding to the first imaging point. Similarly, the display controller 112 extracts the moving images in periods b, c, d, e, and f from the entire moving image as the partial candidate moving images corresponding to the second, third, fourth, fifth, and sixth imaging points.

Next, in a case where one or more detection times included in the second list are included within a period of the partial candidate moving image corresponding to each imaging point j, the display controller 112 detects that the captured image of the annotation object is included in the partial candidate moving image. In this case, the display controller 112 extracts, from the entire moving image, a moving image including only an image including a captured image of the annotation object and having a period overlapping with the partial candidate moving image, as an object moving image corresponding to each imaging point j.

In the example of FIG. 8, the period a of the partial candidate moving image corresponding to the first imaging point includes a plurality of detection times consecutive in a predetermined frame cycle from time ta to time tb included in the second list. Therefore, the display controller 112 detects that the captured image of the annotation object is included in the partial candidate moving image. In this case, the moving image including only the image including the captured image of the annotation object captured at the plurality of consecutive detection times in the predetermined frame cycle from time ta to time tb overlaps with the partial candidate moving image corresponding to the first imaging point in the period from time ta to time tb. Therefore, the display controller 112 extracts the moving image between time ta and time tb from the entire moving image as the object moving image corresponding to the first imaging point.

Since a part of a plurality of detection times consecutive in a predetermined frame cycle from time tc to time td included in the second list is included in the period b of the partial candidate moving image corresponding to the second imaging point, the display controller 112 detects that the captured image of the annotation object is included in the partial candidate moving image. In this case, the moving image including only the image including the captured image of the annotation object captured at the plurality of detection times consecutive in the predetermined frame cycle from time tc to time td overlaps with the partial candidate moving image corresponding to the second imaging point in the period from time tc to time t3. Therefore, the display controller 112 extracts the moving image between time tc and time td from the entire moving image as the object moving image corresponding to the second imaging point.

Since a part of a plurality of detection times consecutive in the predetermined frame cycle from time tc to time td included in the second list is included in the period c of the partial candidate moving image corresponding to the third imaging point, the display controller 112 detects that the captured image of the annotation object is included in the partial candidate moving image. In this case, the moving image including only the image including the captured image of the annotation object captured at the plurality of detection times consecutive in the predetermined frame cycle from time tc to time td overlaps with the partial candidate moving image corresponding to the third imaging point in the period from time t3 to time t4. Therefore, the display controller 112 extracts the moving image between time tc and time td from the entire moving image as the object moving image corresponding to the third imaging point.

Since a part of a plurality of detection times consecutive in the predetermined frame cycle from time tc to time td included in the second list is included in the period d of the partial candidate moving image corresponding to the fourth imaging point, the display controller 112 detects that the captured image of the annotation object is included in the partial candidate moving image. In this case, the moving image including only the image including the captured image of the annotation object captured at the plurality of detection times consecutive in the predetermined frame cycle from time tc to time td overlaps with the partial candidate moving image corresponding to the fourth imaging point in the period from time t4 to time td. Therefore, the display controller 112 extracts the moving image between time tc and time td from the entire moving image as the object moving image corresponding to the fourth imaging point.

Since the detection time included in the second list is not included in the periods e and f of the partial candidate moving images corresponding to the fifth and sixth imaging points, the display controller 112 detects that the captured image of the annotation object is not included in the partial candidate moving image.

Then, upon detection that the captured image of the annotation object is included in the partial candidate moving image corresponding to each imaging point j, the display controller 112 creates, as the partial moving image corresponding to each imaging point j, a moving image (fourth partial moving image) obtained by combining the partial candidate moving image and the object moving image so that the periods do not overlap. The display controller 112 stores the partial moving image in the moving image information storage 123 in association with each imaging point j. Upon detection that the captured image of the annotation object is not included in the partial candidate moving image corresponding to each imaging point j, the display controller 112 stores the partial candidate moving image corresponding to each imaging point j in association with each imaging point j.

In the example of FIG. 8, as described above, the display controller 112 detects that the captured image of the annotation object is included in the partial candidate moving image corresponding to the first imaging point. Therefore, the display controller 112 combines the moving image in the period a from imaging time t1 to imaging time t2, which is the partial candidate moving image corresponding to the first imaging point, and the moving image in the period from imaging time ta to imaging time tb, which is the object moving image corresponding to the first imaging point, so that the periods do not overlap. The display controller 112 creates a moving image in the period a from imaging time t1 to imaging time t2 obtained by this combination as a partial moving image corresponding to the first imaging point, and stores the partial moving image in the moving image information storage 123 in association with the first imaging point.

In the example of FIG. 8, as described above, the display controller 112 detects that the captured image of the annotation object is included in the partial candidate moving image corresponding to the second imaging point. Therefore, the display controller 112 combines the moving image in the period b from imaging time t2 to imaging time t3, which is the partial candidate moving image corresponding to the second imaging point, and the moving image in the period from imaging time tc to imaging time td, which is the object moving image corresponding to the second imaging point, so that the periods do not overlap. The display controller 112 creates the moving image in a period b1 from imaging time t2 to imaging time td obtained by this combination as the partial moving image corresponding to the second imaging point, and stores the partial moving image in the moving image information storage 123 in association with the second imaging point.

In the example of FIG. 8, as described above, the display controller 112 detects that the captured image of the annotation object is included in the partial candidate moving image corresponding to the third imaging point. Therefore, the display controller 112 combines the moving image in the period c from imaging time t3 to imaging time t4, which is the partial candidate moving image corresponding to the third imaging point, and the moving image in the period from imaging time tc to imaging time td, which is the object moving image corresponding to the third imaging point, so that the periods do not overlap. The display controller 112 creates the moving image in a period c1 from imaging time tc to imaging time td obtained by this combination as the partial moving image corresponding to the third imaging point, and stores the partial moving image in the moving image information storage 123 in association with the third imaging point.

In the example of FIG. 8, as described above, the display controller 112 detects that the captured image of the annotation object is included in the partial candidate moving image corresponding to the fourth imaging point. Therefore, the display controller 112 combines the moving image in the period d from imaging time t4 to imaging time t5, which is the partial candidate moving image corresponding to the fourth imaging point, and the moving image in the period from imaging time tc to imaging time td, which is the object moving image corresponding to the fourth imaging point, so that the periods do not overlap. The display controller 112 creates the moving image in a period d1 from imaging time tc to imaging time t5 obtained by this combination as the partial moving image corresponding to the fourth imaging point, and stores the partial moving image in the moving image information storage 123 in association with the fourth imaging point.

In the example of FIG. 8, as described above, the display controller 112 detects that the captured image of the annotation object is not included in the partial candidate moving image corresponding to the fifth imaging point. Therefore, the display controller 112 creates a moving image in the period e from imaging time t5 to imaging time t6, which is a partial candidate moving image corresponding to the fifth imaging point, as a partial moving image corresponding to the fifth imaging point, and stores the partial moving image in the moving image information storage 123 in association with the fifth imaging point.

In the example of FIG. 8, as described above, the display controller 112 detects that the captured image of the annotation object is not included in the partial candidate moving image corresponding to the sixth imaging point. Therefore, the display controller 112 creates a moving image in the period f from imaging time t6 to imaging time t7, which is a partial candidate moving image corresponding to the sixth imaging point, as a partial moving image corresponding to the sixth imaging point, and stores the partial moving image in the moving image information storage 123 in association with the sixth imaging point.

Then, in the modification, in step S28 shown in FIG. 6, the display controller 112 generates the first moving image linked to the first imaging point x as follows.

Specifically, the display controller 112 generates, as the first moving image, a moving image obtained by combining a partial moving image corresponding to the second imaging point x−1 one before the first imaging point x and a partial moving image corresponding to the first imaging point x so that the periods do not overlap.

In the example of FIG. 8, in a case where the first imaging point x is the first imaging point, the display controller 112 generates, as the first moving image, a moving image in the period a from imaging time t1 to imaging time t2, which is a partial moving image corresponding to the first imaging point x.

In the example of FIG. 8, in a case where the first imaging point x is the second imaging point, the display controller 112 combines the moving image in the period a from imaging time t1 to imaging time t2, which is the partial moving image corresponding to the first imaging point one before the first imaging point x, and the moving image in the period b1 from imaging time t2 to imaging time td, which is the partial moving image corresponding to the first imaging point x, so that the periods do not overlap. The display controller 112 generates the moving image in a period a+b1 from imaging time t1 to imaging time td obtained by this combination as the first moving image linked to the second imaging point.

In the example of FIG. 8, in a case where the first imaging point x is the third imaging point, the display controller 112 combines the moving image in the period b1 from imaging time t2 to imaging time td, which is the partial moving image corresponding to the second imaging point one before the first imaging point x, and the moving image in the period c1 from imaging time tc to imaging time td, which is the partial moving image corresponding to the first imaging point x, so that the periods do not overlap. The display controller 112 generates the moving image in the period b1 from imaging time t2 to imaging time td obtained by this combination as the first moving image linked to the third imaging point.

In the example of FIG. 8, in a case where the first imaging point x is the fourth imaging point, the display controller 112 combines the moving image in the period c1 from imaging time tc to imaging time td, which is the partial moving image corresponding to the third imaging point one before the first imaging point x, and the moving image in the period d1 from imaging time tc to imaging time t5, which is the partial moving image corresponding to the first imaging point x, so that the periods do not overlap. The display controller 112 generates the moving image in the period d1 from imaging time tc to imaging time t5 obtained by this combination as the first moving image linked to the fourth imaging point.

In the example of FIG. 8, in a case where the first imaging point x is the fifth imaging point, the display controller 112 combines the moving image in the period d1 from imaging time tc to imaging time t5, which is the partial moving image corresponding to the fourth imaging point one before the first imaging point x, and the moving image in the period e from imaging time t5 to imaging time t6, which is the partial moving image corresponding to the first imaging point x, so that the periods do not overlap. The display controller 112 generates the moving image in a period d1+e from imaging time tc to imaging time t6 obtained by this combination as the first moving image linked to the fifth imaging point.

In the example of FIG. 8, in a case where the first imaging point x is the sixth imaging point, the display controller 112 combines the moving image in the period e from imaging time t5 to imaging time t6, which is the partial moving image corresponding to the fifth imaging point one before the first imaging point x, and the moving image in the period f from imaging time t6 to imaging time t7, which is the partial moving image corresponding to the first imaging point x, so that the periods do not overlap. The display controller 112 generates the moving image in a period e+f from imaging time t5 to imaging time t7 obtained by this combination as the first moving image linked to the sixth imaging point.

In this modification, a moving image including a captured image of an object that can be designated as a target to be annotated in a period immediately before and/or immediately after the imaging time is displayed on the display screen 400 as well as within the imaging time at each of the second imaging points x−1 and x+1 one before and one after the first imaging point x. As a result, the user can gaze at an object that can be designated as a target to be annotated.
(3) In the processing performed in the above embodiment and the above modification (1), among the plurality of series of imaging points, an imaging point n imaging points before one imaging point may be used instead of an imaging point one imaging point before the one imaging point. n is a natural number that is two or more. Similarly, instead of an imaging point one imaging point after one imaging point, an imaging point m imaging points after the one imaging point may be used. m is a natural number that is two or more.

Specifically, in the above embodiment, in step S9 (FIG. 5), the display controller 112 may extract, from the entire moving image as the partial moving image corresponding to the imaging point j, the moving image between the imaging times at each of an imaging point j−n that is n before the imaging point j and an imaging point j+m that is m after the imaging point j.

In the above modification (1), in step S9 (FIG. 5), the display controller 112 may calculate, as the first average time, the average of the imaging times at each of the imaging points j−n that are n before each of the imaging points j and each of the imaging points j. The display controller 112 may calculate, as the second average time, an average of imaging times at each of the imaging points j and the imaging points j+m that are m after each of the imaging points j. Then, the display controller 112 may extract a moving image from the first average time to the second average time as a partial moving image from the entire moving image.

Accordingly, in step S28 (FIG. 6), the display controller 112 may acquire, from the moving image information storage 123, not only the partial moving image corresponding to the first imaging point x but also the partial moving images corresponding to the two second imaging points x−n and x+m n before and m after the first imaging point x. Then, the display controller 112 may generate the first moving image linked to the first imaging point x by using these partial moving images.

More specifically, from the partial moving image corresponding to the second imaging point x−n n before the first imaging point x, the display controller 112 may extract a moving image at and after the imaging time at the second imaging point x−n as the first divided moving image. From the partial moving image corresponding to the second imaging point x+m m after the first imaging point x, the display controller 112 may extract a moving image at and before the imaging time at the second imaging point x+m as the second divided moving image. Then, the display controller 112 may generate, as the first moving image, a moving image obtained by combining the first divided moving image, the partial moving image corresponding to the first imaging point x, and the second divided moving image.
(4) In step S11 (FIG. 7) of the above modification (2), the display controller 112 may detect the detection time that is the imaging time of each of one or more captured images including the captured image of the predetermined object included in the entire moving image by known image recognition processing.

The present disclosure is useful in the technical field of managing the progress of construction at a construction site from a remote place.

1. An information processing method in a computer, comprising:
displaying a bird's-eye view on a display of a terminal device;
displaying, on the bird's-eye view, a plurality of imaging point icons indicating a series of a plurality of imaging points; and
upon detection of a selection of one first imaging point icon among the plurality of imaging point icons, displaying a first moving image linked to a first imaging point indicated by the first imaging point icon,
wherein the first moving image is a moving image between imaging times at each of two second imaging points indicated by two second imaging icons displayed before and after the first imaging point icon.

2. The information processing method according to claim 1, further comprising upon detection of the selection of the first imaging point icon, causing display modes of the two second imaging point icons displayed in the bird's-eye view to be different from a display mode of another imaging point icon.

3. The information processing method according to claim 1, wherein
the displaying of the first moving image includes
displaying time information in which the imaging time of an image included in the first moving image and currently displayed, an imaging time at the first imaging point, and the imaging time at each of the two second imaging points are associated with each other.

4. The information processing method according to claim 3, wherein
the displaying of the time information includes
displaying the imaging time at the first imaging point with an icon having a display mode same as a display mode of the first imaging point icon displayed in the bird's-eye view, and
displaying the imaging time at each of the two second imaging points with two icons having a display mode same as the display mode of each of the two second imaging point icons displayed in the bird's-eye view.

5. The information processing method according to claim 1, further comprising:
extracting a first partial moving image that is a moving image between imaging times at each of the imaging points before and after each of the imaging points from an entire moving image that is a moving image between imaging times at each of an imaging start point and an imaging end point of the plurality of imaging points; and
storing the first partial moving image in association with each of the imaging points,
wherein the displaying of the first moving image includes displaying the first partial moving image corresponding to the first imaging point as the first moving image.

6. The information processing method according to claim 1, further comprising:
extracting a second partial moving image that is a moving image from a first average time that is an average of imaging times at an imaging point before each of the imaging points and at each of the imaging points to a second average time that is an average of imaging times at each of the imaging points and at each of the imaging points after each of the imaging points from an entire moving image that is a moving image between imaging times at each of an imaging start point and an imaging end point of the plurality of imaging points; and
storing the second partial moving image in association with each of the imaging points,
wherein displaying the first moving image includes displaying, as the first moving image, a moving image obtained by combining a moving image at and after an imaging time at a third imaging point in the second partial moving image corresponding to the third imaging point that is a second imaging point before the first imaging point, the second partial moving image corresponding to the first imaging point, and a moving image before an imaging time at a fourth imaging point in the second partial moving image corresponding to a fourth imaging point that is a second imaging point after the first imaging point.

7. The information processing method according to claim 1, further comprising:
extracting a third partial moving image that is a moving image between imaging times at each of the imaging points and each of the imaging points one after each of the imaging points, from an entire moving image that is a moving image between imaging times at each of an imaging start point and an imaging end point of the plurality of imaging points; and
upon detection that the captured image of the predetermined object is included in the third partial moving image, extracting, from the entire moving image, an object moving image that is a moving image including only an image including a captured image of a predetermined object and having a period overlapping with the third partial moving image, and storing a fourth partial moving image that is a moving image obtained by combining the third partial moving image and the object moving image so that periods do not overlap in association with each of the imaging points, and upon detection that the captured image of the predetermined object is not included in the third partial moving image, storing the third partial moving image in association with each of the imaging points,
wherein displaying the first moving image includes
displaying, as the first moving image, a moving image obtained by combining the third partial moving image or the fourth partial moving image corresponding to the second imaging point one before the first imaging point and the third partial moving image or the fourth partial moving image corresponding to the first imaging point so that periods do not overlap.

8. The information processing method according to claim 7, wherein
detecting whether a captured image of the predetermined object is included includes
detecting that a captured image of the predetermined object is included in a third partial moving image when one or more imaging times obtained by inputting the entire moving image to a model obtained by machine learning a relationship between a second moving image that is a moving image captured in a space including the plurality of imaging points and includes one or more captured images of an annotation object existing in the space and an imaging time of each of one or more captured image of the annotation object included in the second moving image is included in a period of the third partial moving image, and
the annotation object is an object designated by a user as a target to be annotated.

9. The information processing method according to claim 1, wherein
an imaging point before one imaging point among the plurality of imaging points is n imaging points before the one imaging point, and
an imaging point after the one imaging point is m imaging points after the one imaging point, and
the n and the m are natural numbers that are one or more.

10. An information processing device comprising a processor,
the processor executing processing of
displaying a bird's-eye view on a display of a terminal device,
displaying, on the bird's-eye view, a plurality of imaging point icons indicating a series of a plurality of imaging points, and
upon detection of a selection of one first imaging point icon among the plurality of imaging point icons, displaying a first moving image linked to a first imaging point indicated by the first imaging point icon,
wherein the first moving image is a moving image between imaging times at each of two second imaging points indicated by two second imaging icons displayed before and after the first imaging point icon.

11. A non-transitory computer readable storage medium storing an information processing program that causes a computer to
display a bird's-eye view on a display of a terminal device,
display, on the bird's-eye view, a plurality of imaging point icons indicating a series of a plurality of imaging points, and
upon detection of a selection of one first imaging point icon among the plurality of imaging point icons, display a first moving image linked to a first imaging point indicated by the first imaging point icon,
wherein the first moving image is a moving image between imaging times at each of two second imaging points indicated by two second imaging icons displayed before and after the first imaging point icon.
